(19) United States
(12) Patent Application Publication
(10) Pub. No.: US 2009/0234775 A1
(43) Pub. Date: Sep. 17, 2009

(54) REAL ESTATE APPRAISAL SYSTEM AND METHOD

(76) Inventors: Jason Whitney, Lee's Summit, MO (US); Bradley Nelson Woodworth, Lee's Summit, MO (US); Manish Sohaney, Stillwell, KS (US); Lars Joseph Hacking, Greenwood, MO (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 12/403,324

(22) Filed: Mar. 12, 2009

Related U.S. Application Data
(60) Provisional application No. 61/036,012, filed on Mar. 12, 2008.

(51) Int. Cl. G06Q 40/00; G06F 12/14; G06F 17/30; G06F 3/048

(52) U.S. Cl. 705/36 R; 707/9; 707/3; 715/760; 707/104.1; 707/E17.009; 707/E17.014

(57) ABSTRACT

The present general inventive concept provides a system and method to facilitate entry of real estate data related to property value, store the real estate data, and track any manipulation thereof, thereby providing secure real estate data with increased accuracy.

### CROSS-REFERENCE TO RELATED APPLICATION

This application for patent claims the benefit of priority from U.S. Provisional Patent Application Ser. No. 61/036,012 filed Mar. 12, 2008, the disclosure of which is incorporated herein by reference in its entirety.

### BACKGROUND OF THE INVENTION

1. Field of the Invention

The present general inventive concept relates to a system and method to store data to provide transparency to users, and more particularly to a system and method to facilitate entry of real estate data related to property value, store the real estate data, and track any manipulation thereof, thereby providing secure real estate data with increased accuracy.

2. Description of the Related Art

The United States residential mortgage market is in financial chaos because loan defaults are at historic highs. The reasons for the massive defaults is attributed to issuance of loans for properties that exceed the true market value of the property.

Financial institutions or “Lenders” are actively engaged to understand the risk in their existing loan portfolio as well as identify methods to lower future risk on new loans. Some conventional methods include analyzing credit risk, which is an important factor to evaluate loan defaults due to low credit, and analyzing appraisal values, which is an important factor to evaluate risk of loss due to inflated property values.

Conventional software programs process appraisal paperwork required by a financial institution customers as part of the home loan evaluation process. This software, which provides the appraisal paperwork in an electronic version, is quicker than completing the same paperwork by hand. Regardless, the form completion phase involves significant manual data entry.

Accordingly, there is a demand for a more efficient way to generate real estate appraisals that are superior to traditional programs that reduce the time spent in the form completion phase to allow the processing of more appraisals with the same staff or the same number of appraisals with fewer staff to generate a lower cost per appraisal. An additional advantage includes quicker appraisal turnaround times.

### SUMMARY OF THE INVENTION

The present general inventive concept provides a system and method to facilitate entry of real estate data related to property value, store the real estate data, and track any manipulation thereof, thereby providing secure real estate data with increased accuracy.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of ensuring anonymity between a requestor of an appraisal and an appraiser including the steps of submitting a request for a valuation for a subject property via a computer terminal linked to a first database, determining whether the valuation for the subject property is in the database, linking the valuation and the subject property to a requester, delivering the request for the valuation for the subject property to an appraiser, and concealing an identity of the requester from the appraiser.

The foregoing and/or other aspects and utilities of the present general inventive concept may further be achieved by sequentially tracking changes made to the valuation for the subject property, and permitting a user to play back changes made to the valuation for the subject property subsequent to the sequentially tracking step.

The foregoing and/or other aspects and utilities of the present general inventive concept may be achieved by providing a method of manipulating, storing, and controlling access to data including the steps of storing information within a database to be accessed by a plurality of users; simultaneously providing each of the plurality of users with one of a plurality of different access levels to the information; recording a change to the information by one of the plurality of users; displaying the change to the information to another of the plurality of users; and determining whether the change is authorized; and generating and displaying a warning if the change is not authorized.

The foregoing and/or other aspects and utilities of the present general inventive concept may further be achieved by comparing the information within the database to information contained within a third-party database.

The third-party database may be a property-listing database including properties for sale and property-tax information.

A first level of the plurality of different access levels may be a read-only level, a second level of the plurality of different access levels may be a write level, and a third level of the plurality of different access levels may be a read-write level.

The foregoing and/or other aspects and utilities of the present general inventive concept may be achieved by providing a computer readable recording medium comprising computer readable codes to provide web-pages to manage information including comparing first data input into a first field with second data contained in a database, populating a second field if the first data matches the second data to yield third data, storing the third data to permit display of the third data from a first user terminal, generating a web-page based on the third data if displaying of the web-page is requested from the first user terminal, and recording a change to the stored data made from the first user terminal.

If the change conflicts with a rule, a warning may be generated for display at a second user terminal.

The foregoing and/or other aspects and utilities of the present general inventive concept may further be achieved by including a play-back feature to permit display of a sequence in which the first data, the second data, or the third data was input.

The foregoing and/or other aspects and utilities of the present general inventive concept may be achieved by including a play-back feature to selectively display of a sequence in which the first data, the second data, or the third data has been sequentially changed from a first stale to a second state to a third state.

the foregoing and other objects are intended to be illustrative of the present general inventive concept and are not meant in a limiting sense. Many possible embodiments of the present general inventive concept may be made and will be readily evident upon a study of the following specification and accompanying drawings comprising a part thereof. Various features and subcombinations of present general inventive concept may be employed without reference to other features and subcombinations. Other objects and advantages of this present general inventive concept will become apparent from the following description taken in connection with the accompanying drawings, wherein is set forth by way of illustration and example, an embodiment of this present general inventive concept.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a flowchart of the present general inventive concept illustrating a plurality of databases linking to a primary database of the present general inventive concept.

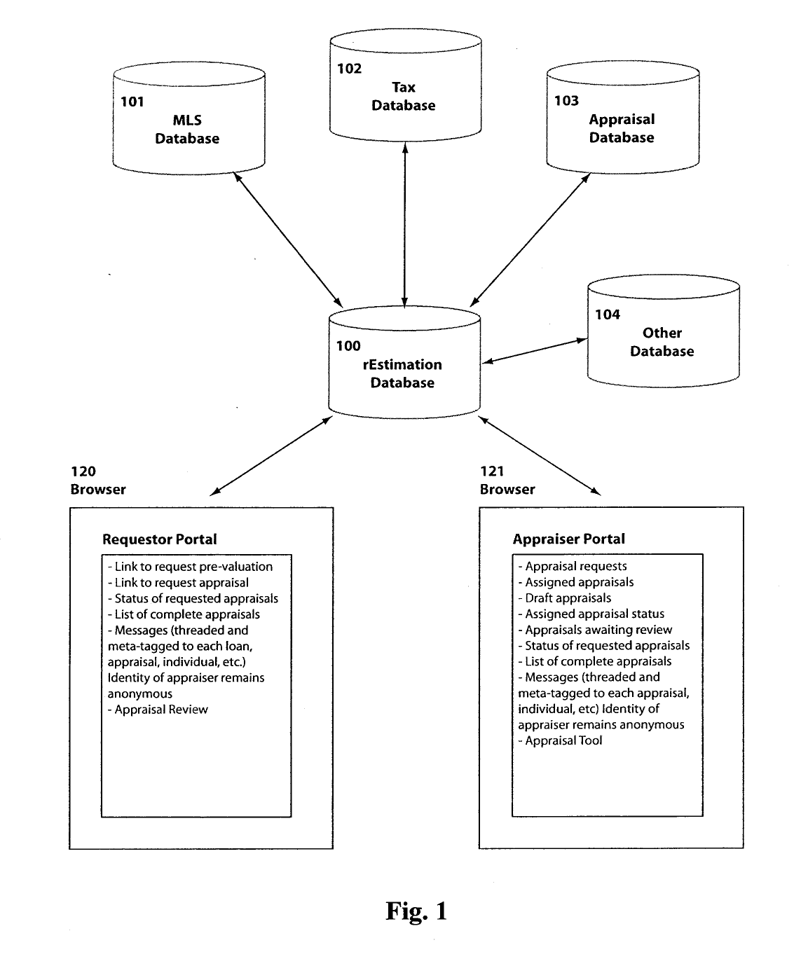

FIG. 2 is a view of a user control screen of the present general inventive concept illustrating an overview of loans, accounts, clients, and messages.

FIG. 3 is a view of a user control screen of the present general inventive concept illustrating an overview of appraisals, accounts, clients, and messages.

FIG. 4 is a view illustrating a mapping function of the present general inventive concept depicting properties listed within a proximity to a subject property for comparison with the subject property and may be selected for additional information.

FIG. 5 is a view illustrating a detailed valuation function of the present general inventive concept providing a plurality of factors related to a vicinity of a subject property that may be used to increase or decrease a valuation of a subject property.

FIG. 6 is a view illustrating a detailed valuation function of the present general inventive concept providing a plurality of factors related to a subject property a comparable properties that may be used to increase or decrease a valuation of a subject property.

### DETAILED DESCRIPTION OF THE INVENTION

The present general inventive concept provides a system and method to ensure a valuation or appraisal of property is accurate. While the present general inventive concept is web-based software in the exemplary embodiment, it is foreseen that the present general inventive concept may be used on a local medium.

The present general inventive concept enables appraisers and/or lenders to complete and/or order appraisals for all new home mortgages, home refinancing loans, home equity lines of credit, and the like. The purpose of the appraisal is to establish whether there is sufficient value in the home to provide collateral in case of a default on the loan. Because appraisals permit a Lender to evaluate the risk associated with a loan such that a decision as to whether or not to make the loan can be executed, accurate appraisals are of the utmost importance. Appraisals are completed by State-certified appraisers.

To complete an appraisal, an appraiser travels to a subject property and performs a physical inspection of the exterior, and if requested, the interior. The appraiser evaluates the condition of the property and its physical attributes. Thereafter, the appraiser attempts to compare the property to comparable properties in the vicinity.

To provide a comparison, the appraiser may refer to a plurality of databases including home-listing databases, tax records databases, and/or title record databases. An example of a home-listing database is the Heartland Multiple Listing Service (“MLS”) web-based database (“the MLS database”). Ideally, the appraiser attempts to locate at least three comparable properties that are geographically proximate to the subject property and in similar neighborhoods which have recently sold in order to find properties with comparable attributes to the subject property.

The Appraiser then establishes a value for the subject property by making monetary adjustments for the material differences between the comparable properties. Once a value has been determined for the subject property, the appraiser completes one or more industry-standard forms, depending on applicability, either manually or via form-filling software. The completed form(s) is then sent to the lender for their consideration so that the lender may determine the value of the subject property and whether to issue a loan.

The present general inventive concept may have a wholly self-contained database or link to other databases, such as the MLS database. The MLS database provides most of the information needed to complete the appraisal paperwork. As such, in the exemplary embodiment, there is an electronic feed between the MLS database and the present general inventive concept.

In the situation that an appraisal amount does not evidence that the subject property has sufficient value to justify a loan, the appraiser may receive pressure from the banker, realtor and/or mortgage broker to “review” the appraisal for certain minimum value. This reality provides fertile ground for fraud as the Appraiser relies on these individuals for future and referral business.

For Appraisers, the present general inventive concept provides the following benefits. Completing the industry standard appraisal forms averages about three hours per appraisal. The present general inventive concept reduces the data-entry portion to seconds, while also eliminating manual data entry errors. The present general inventive concept interfaces with the MLS database, tax records, title records, and/or previously completed appraisals to seamlessly pre-populate the industry standard forms with the physical attribute information required to complete the appraisal.

The present general inventive concept utilizes complex algorithms to analyze and select the best available data for each cell. The Appraiser has the option of keeping the selected data, overriding it with the Appraiser's own data, or choosing from one or more of a plurality of alternative data sources. The present general inventive concept records any changes to a property record and stores it in servers of the present general inventive concept. The recorded modification can then be reviewed and evaluated each time the record is used. The process ensures that the database of the present general inventive concept is more dynamic with increased transparency and accuracy relative to the source database for at least the reason that information contained in the database of the present general inventive concept has either been validated or displays what portions have been modified. Consequently, it may be easily determined whether data has been manipulated to contain false information that may mislead lenders into issuing a loan based on, for example, falsely inflated subject property values.

The present general inventive concept permits Appraisers to store information and/or their appraisals in one or more online databases or “cyber vaults.” In this manner, the Appraiser may easily incorporate stored information, which has already been verified, into new appraisals. Thus, the present general inventive concept encourages storing of information.

The present general inventive concept also permits Appraisers to share and/or access stored information of other appraisers. In this manner, appraisers may access each others historical appraisal information, which includes physical attributes that have already been validated by others, thereby facilitating entry of data. Thus, the present general inventive concept encourages sharing of information.

The present general inventive concept may now analyze the stored information for comparison of the data against source databases and thereby improve the data at an accelerated pace. Such improvement may include updates to the properties that may increase or decrease their values. Increases may be due to new roofs or wings or general appreciation of the property area. Decreases may be due to failure to repair damage or general depreciation of the property area.

Lenders are also provided a number of distinct advantages over the prior art. For instance, when one applies for a loan to purchase a property, such as a residential real estate loan, banks often purchase a property pre-valuation in order to ensure that the amount of the loan request is at or below the property's value. A pre-valuation is not an appraisal, but rather an estimate of a property's value based upon secondary source information. The intent of a pre-valuation is to screen bad business opportunities to ensure that the bank only invests time and money on good business opportunities while investing minimal time and money in bad business opportunities. This is accomplished through the present general inventive concept's ability to immediately provide an analyzed comparison of a requested loan amount for a subject property with information contained within the database of the present general inventive concept. The information is provided with a degree of accuracy that can be easily evaluated. In this manner, the present general inventive concept allows a bank to screen potentially valuable clients from clearly bad clients earlier than any conventional means, which makes the present general inventive concept an ideal pre-valuation source.

The present general inventive concept simultaneously provides each of a plurality of users with a separate security level that is different from each other. In this manner, a first user may have complete access or high-level access to the database of the present general inventive concept to execute administrative changes, a second user may have mid-level access to add information, but not delete information contained within the database, and a third user may have low-level access to only view information contained within the database.

Lenders who require their appraisers to use the present general inventive concept will have visibility of any and all changes that the appraiser makes to the date already contained within the database. Any changes can be easily analyzed such that Lenders may determine whether further investigation is necessary, e.g., a second appraisal and/or a follow-up interview with the Appraiser. Consequently, the present general inventive concept acts to deter input of false information.

The present general inventive concept also provides a means to evaluate an existing portfolio of loans. For example, a Lender can input existing loans of properties into the database of the present general inventive concept to identify any properties identify properties having a value that deviates from established criteria. Any properties that deviate to a degree or parameters set by the Lender will generate a warning to the Lender for further analysis by the Lender, e.g., a second appraisal and/or a follow-up interview with the Appraiser. It is foreseen that the warning may be generated via display to the Lender, but also may be reported to the Lender via email with logic for the warning.

In the exemplary embodiment, the MLS database provides web-based access to limited historical data, a link on an MLS database website links the MLS database to a website of the present general inventive concept, and access to the MLS database of appraiser members. It is foreseen that by using information derived from the MLS database, the present general inventive concept will be able to automatically populate much information provides additional data since many use the MLS database as a primary means to research properties that are comparable to a subject property.

The present general inventive concept also provides realtor valuations. Each time a realtor lists a home, the realtor assist the seller by estimating a fair selling price. Realtors frequently rely on vendors that sell an valuation service in an independent form. The present general inventive concept streamlines the valuation service using data and means for valuation that is essentially the same as the pre-valuation product for lending institutions, as already provided by the general present inventive concept.

Aside from user fees generated by the general inventive concept, it is foreseen that additional revenue may be generated via advertising links on a website or access portal of the present general inventive concept. For example, when a user such as an appraiser sign up for use of the present general inventive concept, the user completes a profile page such that when the user subsequently logs onto and accesses the portal, a start page that contains advertisements is displayed. These advertisements may be user specific based on the user's profile. In this manner, high-value advertisements may be tailored and targeted to a specific audience using the profile. Key information from the profile may be, but not limited to, a user-inputted search history, geographic area of the user, and/or general user information.

In addition to the aforementioned discussion of various features of the present general inventive concept, further detail is provided via the following disclosure.

Currently, there is no method or system to provide transparency of data while maintaining anonymity in the appraiser-lender relationship. This lack of transparency in data makes reviewing and validating the appraisal process difficult to impossible. The lack of maintaining anonymity increases the risk of fraud through improper appraiser-lender relationships where the individual lending agent has an incentive to finalize a loan, which leads the lending agent to apply pressure on the appraiser to get the appraisal raised to a certain valuation that will justify finalization of the loan.

The present general inventive concept provides anonymous transparency in the appraiser lender process. By combining the appraisal request system and the appraisal evaluation system, the present general inventive concept provides a “pass through” of data that can be viewed by both the requester and the appraiser. Also, by maintaining appraiser and requester identities within the system but presenting them in an anonymous fashion, the present general inventive concept provides anonymous transparency of data while maintaining an acceptable level of communication and interaction between the anonymous parties. It is foreseen that the level of transparency may be controlled to provide complete transparency to no transparency as well as any level of transparency therebetween. Such control may be accomplished by providing a plurality of users with different levels of access to the present general inventive concept.

For instance, three different levels may be providing such as a first level that is a read-only level, a second level that is a write level, and a third level that is a read-write level. It is foreseen that the third level is reserved for administrators.

Further, information displayed to second level users may not be displayed to first level users. In this manner, anonymity between parties can be ensured, but vary from system to system.

It is foreseen that communication between the present general inventive concept and users thereof and/or between users of the present general inventive concept may include texting via cellular phones, instant messaging, and/or emailing via personal data assistants and/or computers, and the like.

Third level controllers may selectively set the present general inventive concept to track open messaging and may block or restrict one or more user's communication abilities.

The benefits of transparency act to eliminate fraud in the appraisal-lender real estate process. Currently, it is estimated that there are billions of dollars in fraudulent loans outstanding in the United States alone as well as in other countries. By providing a greater level of transparency in the presentation of data to appraisal reviewers, senior appraisers, lenders, and the like, the present general inventive concept is able to dramatically increase the likelihood that errors will be noticed and corrected prior to issuing a loan.

Further, by offering a communication method that is anonymous through the entire process, the present general inventive concept reduces the probability of “subjective” data that is influenced by the current relationship model. A standard deviation may be used to red flag subject data.

It is also foreseen that geostamping may be incorporated into the present general inventive concept. Geostamping would allow a reviewer to verify the precise location any photograph was taken and used for an appraisal. Geostamping may include latitude and longitude coordinates, directionality to indicate a direction a camera was pointing then the photographed was taken, date, time, and/or the like. This feature enables a user to ensure the depicted real estate is the correct real estate.

It is also foreseen that the present general inventive concept may include a scaling feature that may be applied to any photograph taken and used for an appraisal. Scaling would identify any standard or known sizes and/or lengths within the picture, such as a doorway, to enable scaling of an unknown object, such as a house. This feature enables a user to further ensure the pictured real estate is the correct real estate.

Currently there is no system in which the appraisal process can be tracked through each step in the appraisal process and tied to requester, the assigned appraiser, the reviewer and the submitter. This lack of tracking does not allow for flexibility, makes reviewing difficult to impossible and allows for unacceptable inaccuracies in the final valuation of the property being reviewed. Also, this lack of structured information and resource management makes it difficult to impossible for appraisal firms to grow beyond a few appraisers as it puts unacceptably high levels of responsibility on the reviewer and resource manager.

The present general inventive concept provides a method and system to manage appraisals and appraisers in a real estate appraisal system by providing a system that both assists in the process and tracks the appraisal through any one or more of the following touch points: request, received, draft, review submission, review, and/or final submission. While a user navigates through these points, the present general inventive concept may create, manage, and otherwise facilitate the relationship between any one or more of the appraiser, requester, reviewer, and/or submitter. This may be achieved by creating a single system using meta-relationships.

By assisting the senior appraiser, reviewer, and/or resource manager at one or more of the aforementioned touch points, the present general inventive concept may greatly improve reviewer accuracy, process speed and communication. The present general inventive concept enables appraisal firms to provide not only the ability to provide a higher level of accuracy, but also to grow exponentially in their ability to complete and review appraisals given the significant increase in efficiency provided by the concept as well as the reduced need or lack of increase in human reviewing resources. In other words, this feature may eliminate or at least limit secondary review, such as reviews by HUD, which are conducted after a loan default. Thus, this automation feature prevents defaults by providing information and a degree of scrutiny for review prior to a loan is ever issued.

Currently there is no method or system in which the process for searching and selecting and rejecting subject properties for comparison value in the appraisal process can be comprehensively reviewed. Without this historical review of each step in the process, it is difficult to impossible for a reviewer to identify problems or discrepancies.

The present general inventive concept provides a method and system for capturing and presenting a subject property search, selection, and/or rejection process. By capturing the search criteria submitted by a first user manipulating the property search, selection, and/or rejection, the sequence or order in which the property submissions occur, the total number of property submissions and the results that are returned, the present general inventive concept allows a second user, such as a lender, to review or “re-play” every step the first user made, thus revealing to the second user the entire comparison search and selection process.

By allowing the second user to re-play the comparable selection process, the present general inventive concept offers an accurate and efficient method to review appraisal information. The present general inventive concept assists the second user reviewer, such as a senior appraiser, lender, borrower, and/or the like in assessing more appraisals in less time and with greater accuracy.

It is foreseen that searches and search criteria from a first user may be stored and suggested to a second user when its similarities are detected between information inputted by a second user and stored information entered by the first user. In other words, the general inventive concept learns or builds a database of searches for future suggestions based on history of a user, users related to the user, the subject property, and/or properties related to the subject property.

Currently there is no method or system that offers the ability to display comparable property relevance in relation to key factors of the subject property. Without this ability, the selection process can take an unacceptably long time as well as provide less accurate results.

The present general inventive concept provides a method and system to display comparable property relevance in a search, increases comparable selection efficiency, and/or increases selection accuracy in the appraisal process. Such is accomplished by analyzing various existing data such as communities, zip codes, and/or the like to find ideal comparisons. Other data can be contrasted such as but not limited to subdivisions versus square footage. An algorithm may be employed to analyze historical sales volume and ratios. This data may be contained within a database of the present general inventive concept or a third-party database, such as the MLS database.

Because easily accessible existing data is analyzed, the present general inventive concept is able to generate a result using the newest available data. This “real-time” data provides high accuracy as opposed to conventional systems that use older data having a significant lag time. Thus, the present general inventive concept generates most recent data thereby enabling a user to make a decision with increased clarity prior to committing to the property.

Currently there is no method or system that offers the ability to capture both the data and the process in which data was selected and entered in the appraisal process and to allow the reviewer to make changes to that data without losing the integrity of the original data before final submission.

The present general inventive concept provides a method and system to capture and display updated information into historical data in the real estate appraisal process. This is accomplished by capturing both the data and the process in which data was selected and entered in the appraisal process and allowing the reviewer to make changes to that data without losing the integrity of the original data before final submission. In other words, although the reviewer makes changes, the original data is saved. As such, the first data entered or first layer of data is stored even though the reviewer enters more data or a second layer of data. It is foreseen that there can be any number of layers of data to correspond with the number of times data is entered.

Data is first captured at each point of submission. This capturing process stores the order in which changes are made and submitted. The stored information may then be presented to a user in a manner that is similar to playing a movie, i.e., playback of the changes may be paused, forwarded, and/or rewound to provide sequential reviewing.

For example, when a first user enters or submits new data regarding a property, that layer becomes the first layer. When a second layer submits updated data regarding the property, that layer becomes the second layer. This ongoing process permits an end user to analyze each user submission sequentially in the manner they were entered, some of the submissions, or all of the submissions by selecting and/or deselecting layers.

The present general inventive concept may be configured to allow the reviewer to make changes to any data fields at any point in the “playback.” This will be accomplished via a layered manner so that on the new layer, the fields that are edited and changed will reflect the change as well as any other fields that these changes would affect or “cascade” down to. The reviewer can, at any point, toggle back and forth between the review layer and the original layer to see how any changes differ from the original. Upon final submission, the reviewer can choose which layer to submit as “final.”

This feature of the present general inventive concept provides tremendous flexibility by facilitating a reviewer's ability to quickly, efficiently, and accurately make changes.

Various embodiments of the present general inventive concept can be embodied as computer readable codes on a computer readable recording medium. The computer readable recording medium may include any data storage device suitable to store data that can be thereafter read by a computer system. Examples of the computer readable recording medium include, but are not limited to, a read-only memory (ROM), a random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Various embodiments of the present general inventive concept may also be embodied in hardware or in a combination of hardware and software.

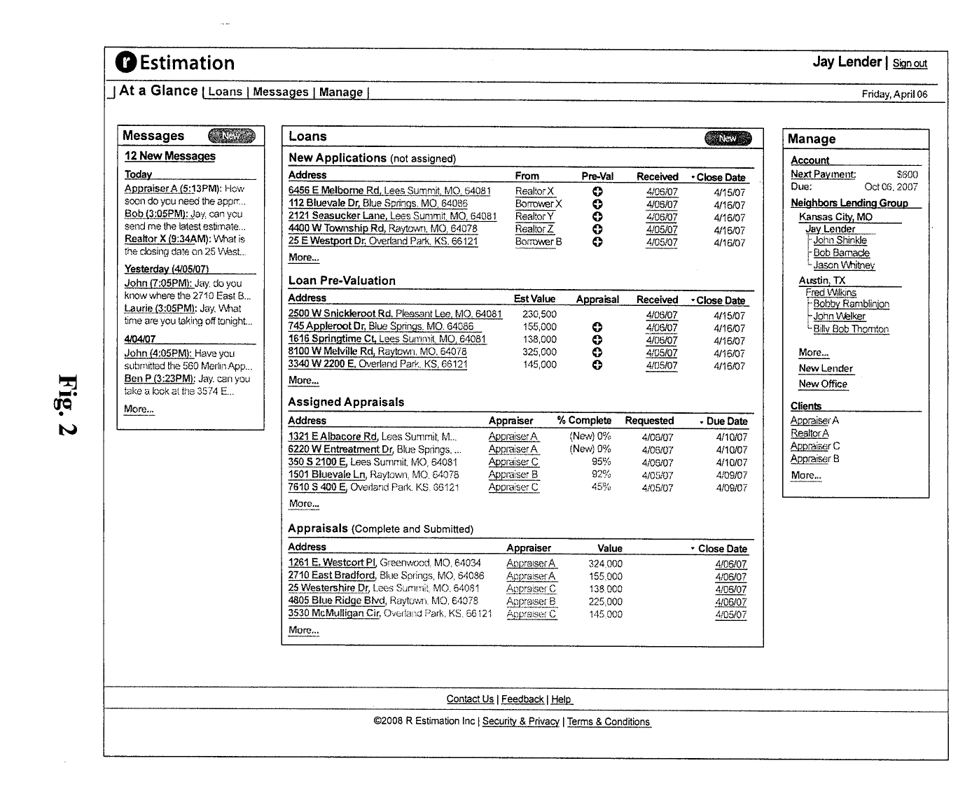

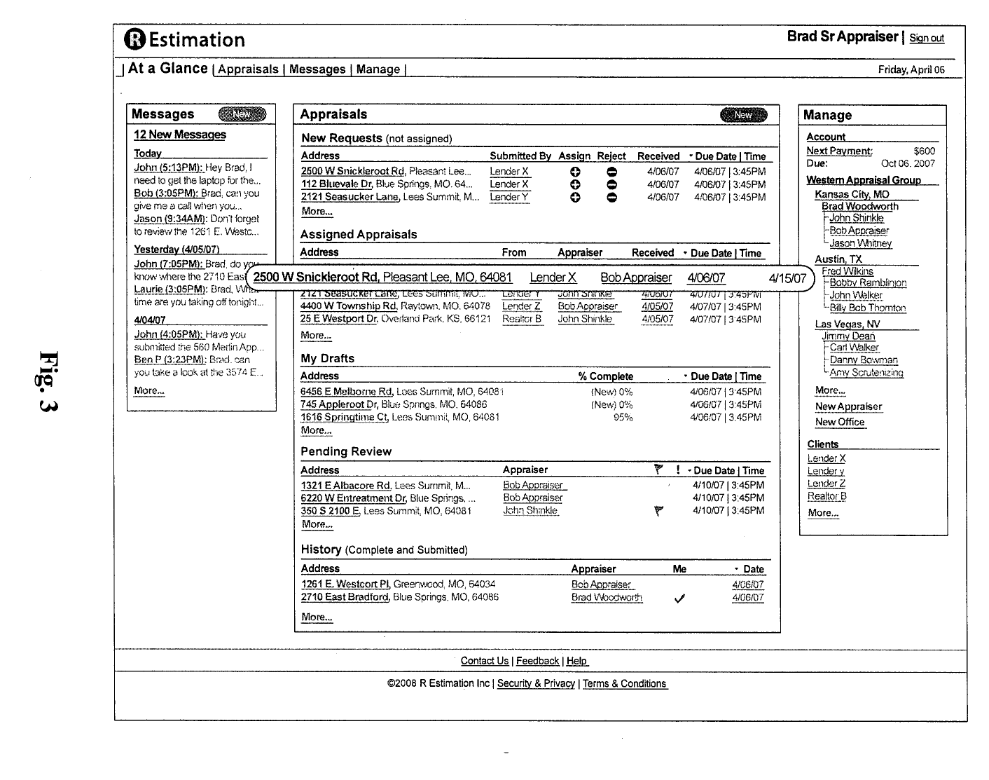

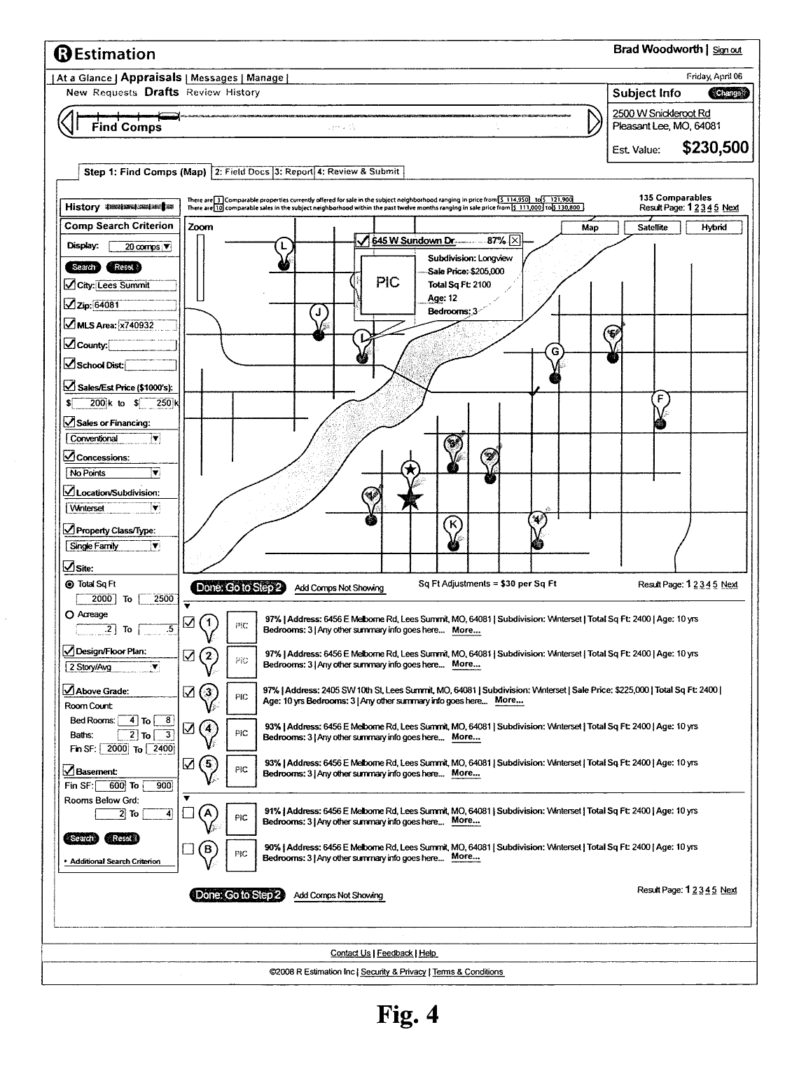

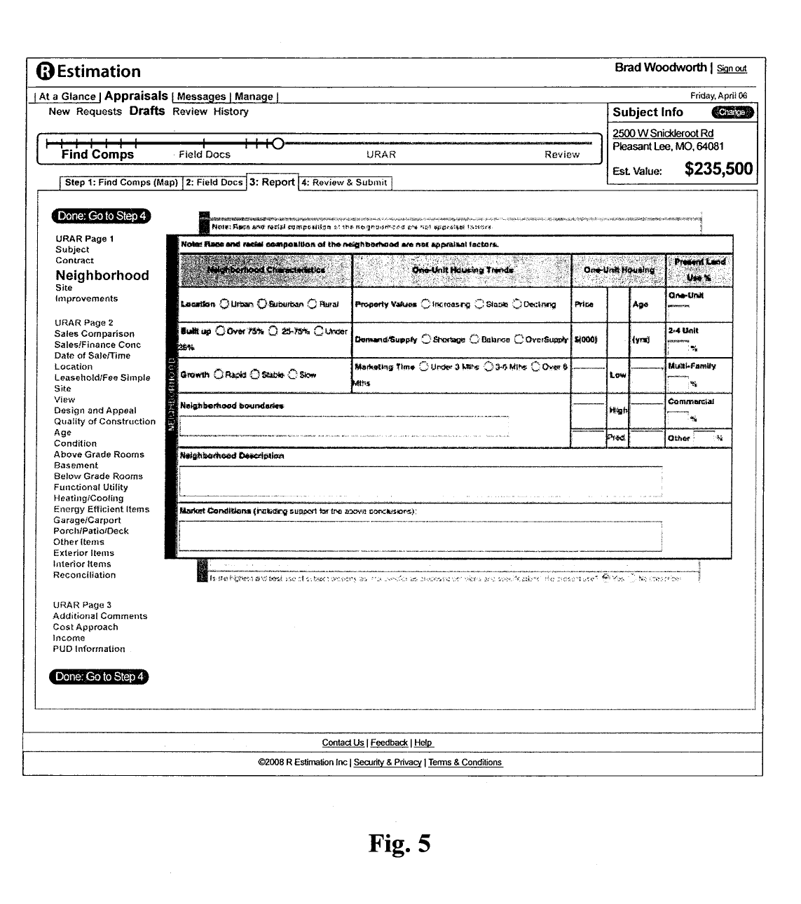

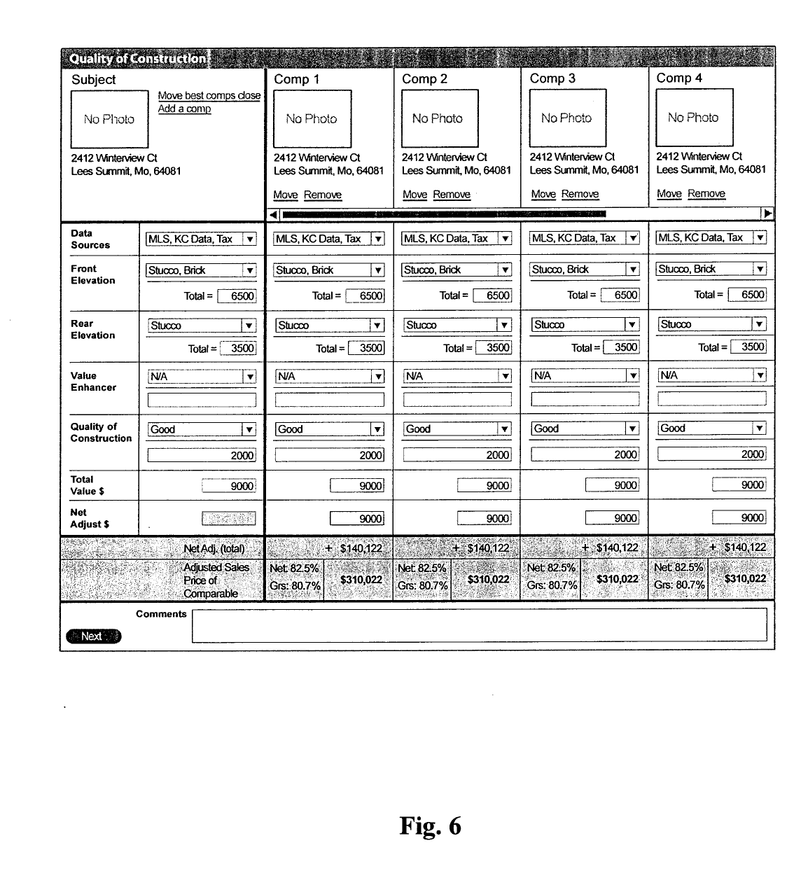

For example, the database of the present general inventive concept may be embodied in software, in hardware, or in a combination thereof. In various embodiments, database of the present general inventive concept may be embodied as computer readable codes on a computer readable recording medium to perform data transmission operations, such as the operations illustrated in FIGS. 2-6.

The foregoing description of the embodiments of the invention has been presented for purposes of illustration and description, and is not intended to be exhaustive or to limit the invention to the precise form disclosed. The description was selected to best explain the principles of the invention and practical application of these principles in order to enable others skilled in the art to best utilize the invention in various embodiments and with such modifications as are suited to the particular use contemplated. It is intended that the scope of the invention not be limited by the specification, but be defined by the claims as set forth below.

What is claimed is:

1. A method of ensuring anonymity between a requestor of an appraisal and an appraiser, the method comprising the steps of:
submitting a request for a valuation for a subject property via a computer terminal linked to a first database;
determining whether the valuation for the subject property is in the database;
linking the valuation and the subject property to a requester;
delivering the request for the valuation for the subject property to an appraiser; and
concealing an identity of the requestor from the appraiser.

2. The method according to claim 1, further comprising the step of:
sequentially tracking changes made to the valuation for the subject property; and
permitting a user to play back changes made to the valuation for the subject property subsequent to the sequentially tracking step.

3. A method of manipulating, storing, and controlling access to data, the method comprising the steps of:
storing information within a database to be accessed by a plurality of users;
simultaneously providing each of the plurality of users with one of a plurality of different access levels to the information;
recording a change to the information by one of the plurality of users;
displaying the change to the information to another of the plurality of users; and
determining whether the change is authorized; and
generating and displaying a warning if the change is not authorized.

4. The method according to claim 3, further comprising the step of:
comparing the information within the database to information contained within a third-party database.

5. The method according to claim 4, further comprising the step of, wherein the third-party database is a property-listing database including properties for sale and property-tax information.

6. The method according to claim 3, wherein a first level of the plurality of different access levels is a read-only level, a second level of the plurality of different access levels is a write level, and a third level of the plurality of different access levels is a read-write level.

7. A computer readable recording medium comprising computer readable codes to provide web-pages to manage information, comprising:
comparing first data input into a first field with second data contained in a database;
populating a second field if the first data matches the second data to yield third data;
storing the third data to permit display of the third data from a first user terminal;
generating a web-page based on the third data if displaying of the web-page is requested from the first user terminal; and
recording a change to the stored data made from the first user terminal.

8. The computer readable recording medium according to claim 7, wherein if the change conflicts with a rule, a warning is generated for display at a second user terminal.

9. The computer readable recording medium according to claim 7, further comprising:
providing a play-back feature to permit display of a sequence in which the first data, the second data, or the third data was input.

10. The computer readable recording medium according to claim 7, further comprising:
providing a play-back feature to selectively display of a sequence in which the first data, the second data, or the third data has been sequentially changed from a first state to a second state to a third state.
